(19) United States
(12) Patent Application Publication
(10) Pub. No.: US 2017/0089098 A1
(43) Pub. Date: Mar. 30, 2017

(54) SECURITY OF AIRPORT LUGGAGE SCREENING

(71) Applicant: DAVID TROPP, Brooklyn, NY (US)

(72) Inventor: DAVID TROPP, Brooklyn, NY (US)

(73) Assignee: SAFE SKIES, LLC, BROOKLYN, NY (US)

(21) Appl. No.: 15/278,787

(22) Filed: Sep. 28, 2016

Related U.S. Application Data
(60) Provisional application No. 62/233,703, filed on Sep. 28, 2015.

(51) Int. Cl. E05B 19/20; E05B 35/10; G08B 13/14; E05B 19/00

(52) U.S. Cl. CPC E05B 19/20; E05B 19/0082; E05B 35/105; G08B 13/14

(57) ABSTRACT

A master key for use in luggage screening by Government entities such as the TSA in this country or comparable organizations in other countries, or private entities authorized to screen travelers' luggage, such as at airports. The master keys are provided with facilities to enhance security and make it more difficult to misuse the keys, and may be a part of an overall system that includes components remote from the keys but interacting with them to improve security.

### CROSS-REFERENCE TO RELATED APPLICATIONS

This application claims the benefit of U.S. Provisional Application No. 62/233,703 filed Sep. 28, 2015 and entitled “IMPROVED SECURITY OF AIRPORT LUGGAGE SCREENING”.

### TECHNICAL FIELD

This application relates to airport luggage screening and specifically to improving the security of components thereof.

### BACKGROUND

In the United States, the Transportation Security Administration (TSA) and other authorized entities screen checked luggage of travelers before it is loaded in aircraft, and similar entities in other countries carry out similar luggage screening. In some cases, the luggage is locked with special locking mechanisms that the TSA and other screening entities can open with a master key and re-lock, thus leaving the luggage secured so that the traveler can later open it by a different manipulation of the locking mechanism, such as by turning combination lock dials or using a traveler's key.

It is important to maintain the master key secure because the same master key can open many of the special locks. Typically, the master key is only in the possession of authorized parties, but the nature of the screening process makes it difficult to prevent unintended transfer of at least one type of master key to unauthorized parties. Indeed, in a widely reporter recent incident, master keys of one of the two suppliers of such keys to the TSA were photographed, the Washington Post published the picture, and the keys were reproduced, reportedly by 3D printing by unauthorized parties and can open millions of travelers' bags. See for example a story in the International Business Times of Sep. 11, 2015, by Mary-Ann Russon.

This patent application is directed to improving the security of airport luggage screening by making more secure the control over and the use of the master key that the published reports do not report as compromised by such photographs and of future master keys for use by the TSA and similar luggage screening entities.

### SUMMARY

Disclosed are examples of key features and methods of making and using keys that improve key security, especially in the context of master keys used by the TSA and other luggage screening entities to screen checked luggage of travelers.

In various embodiments, the improved security arrangements include features and procedures that facilitate detection of removal of keys from authorized areas or making unauthorized use of keys, such as the keys used by the TSA and other entities to open and re-lock dual function locks on travelers' luggage, and facilitate tracing unauthorized photographing and duplication of such keys.

### BRIEF DESCRIPTION OF THE DRAWING

FIG. 1 is a top view of an example of a key with enhanced security features.

FIG. 2 is a side view of the key.

FIG. 3 is a schematic illustration of the key of FIGS. 1 and 2 and an associated RFID reader.

FIG. 4 is a schematic illustration of use of keys similar to that of FIG. 1 and with two types of associated RFID readers.

### DETAILED DESCRIPTION OF EXAMPLES OF EMBODIMENTS

A detailed description of examples of preferred embodiments is provided below. While several embodiments are described, it should be understood that the new subject matter described in this patent specification is not limited to any one embodiment or combination of embodiments described herein, but instead encompasses numerous alternatives, modifications, and equivalents. In addition, while numerous specific details are set forth in the following description in order to provide a thorough understanding, some embodiments can be practiced without some or all of these details. Moreover, for the purpose of clarity, certain technical material that is known in the related art has not been described in detail in order to avoid unnecessarily obscuring the new subject matter described herein. It should be clear that individual features of one or several of the specific embodiments described herein can be used in combination with features or other described embodiments. Further, like reference numbers and designations in the various drawings indicate like elements.

In general, the aim of the examples described in this patent specification is to make it more difficult for a master key used by the TSA and similar entities to reach unauthorized parties. These embodiments take into account the unique circumstances of airport luggage screening and the use of a master key by the TSA and similar entities, and consider both various processes and various automated means to improve key security and accountability. The term “master key” as used in this patent specification includes mechanical or electronic keys and tools designed to mate with a locking mechanism to open and re-lock it.

In one embodiment, a mechanical master key has a blade with a keyway and a bitting with cuts therein to interact with internal components of a lock, and a bow or handle used to turn the key. In typical use, many copies of the same master keys are in distributed to screening agents who use them to open and re-lock locking mechanisms that have indicia relating them to that master key. The indicia of the locking mechanisms that can be opened with the compromised master keys are diamond-shaped marks. The indicia of the locking mechanisms associated with the non-compromised master key are in the shape of a torch. When a screening agent wants to open locking mechanisms that carry the torch indicia, the agent uses the master key issued to him or her, screens the luggage, and re-locks the mechanism using the same master key. There are hundreds of airports with luggage screening facilities in the U.S., and many airports with such facilities overseas, so there are many copies of the master key in use. Improving security over the keys can be both important and difficult to achieve in practice, as there can be many way in which a master key can reach a party not authorized to have it, some inadvertent and some deliberate. For example, an agent can forget a key in or on screened luggage, or can forget it in a pocket or purse, carry it out of a screening facility, and lose it or mislay it at a location that is not secure. Personnel with authorized access to the master key can allow photographing of key without preventing distribution of the photographs to unauthorized persons who can use these photographs to re-create the key, as apparently occurred in the reported incident cited above. Personnel with authorized access can deliberately copy a key or allow others to copy it.

In one embodiment, a security device is included in or attached to a master key. The security device can be associated with security equipment that guards against removal of the key from a secure facility. The security device can be embedded in or affixed to a key, or it can be otherwise secured to a key, and can be passive or active. An example of a passive security device is a radio frequency identification (RFID) tag that can be simply an antenna, preferably tuned to a selected frequency or set of frequencies, or can be also include an integrated circuit (chip) powered by energy received by the antenna or independently, for example by a battery, and configured to store and transmit information such as an identification of the key and/or the person(s) with authorized access to the key. An example of an active device is a device configured to transmit energy, for example radio frequency (RF) energy, with or without prompting by or receipt of energy from an outside device.

In the unique environment of airport luggage screening, and unlike merchandize control system in other environments, the key security system can include configurations that guard against removal of keys from their immediate assigned location, for example the immediate vicinity of a workstation at which a screening agent screens luggage, rather than or in addition to guarding against removal of keys through an exit from enclosed space. To this end, each workstation can be provided with a security device reader that interrogates a key assigned to that workstation to determine if the key is still present in the immediate vicinity of the station. This interrogation can be at selected times, for example every few minutes, or a few times per work shift, or at the start or end of an agent' shift. Alternatively or in addition, RFID readers can be placed at exits from a secure facility, to detect unauthorized removal of keys from a facility. Any reader can be configured to issue an alarm upon detecting unauthorized absence of a key from the vicinity of its designated location or the unauthorized removal of a key from a secure facility, such as an audible and/or visible alarm, and/or to register the time and place of unauthorized movement of a key.

In other embodiments, master key security can be enhanced by methods of improving key accountability and tracking of keys. For example, each master key can be marked with one or more of: the name or other designation of the airport facility to which it is assigned; a designation of the workstation to which the key is assigned; the name of other designation of the accountable property officer responsible for the key or keys assigned to the care of that officer; a serial number of the key; the name or other designation of the screening agent; and/or other markings. The markings can be engraved or molded or imprinted or in the form of stickers, or can be placed on or in the key some other way, and can be at one or more places on the key, e.g., on one or both sides of the key blade, on a portion of the key blade that extends into the key handle and in not visible in normal usage of the key, on one or more sides of the key bow (handle), and/or on attachments to the key or bow that can be fixedly or remove ably attached to the key.

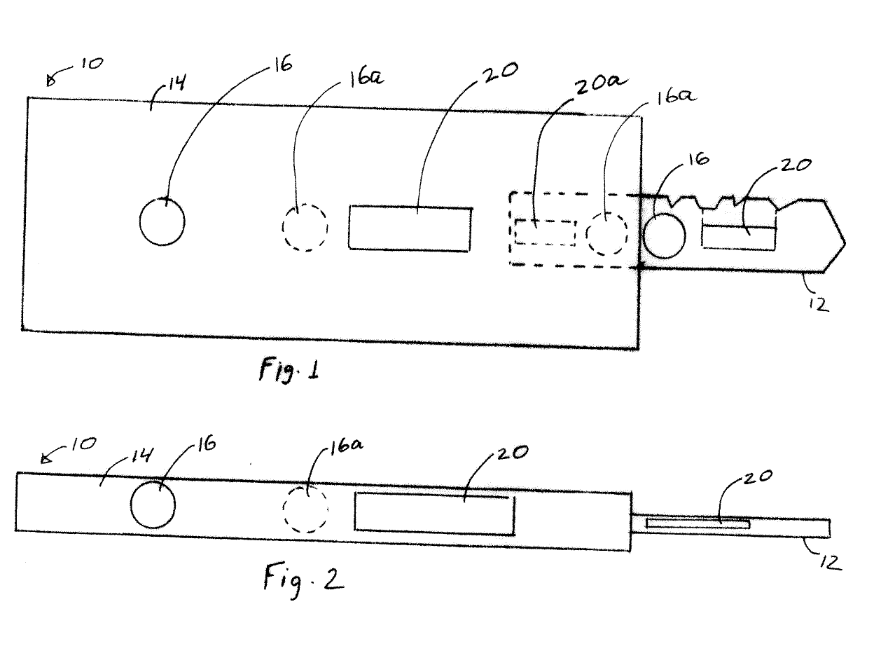

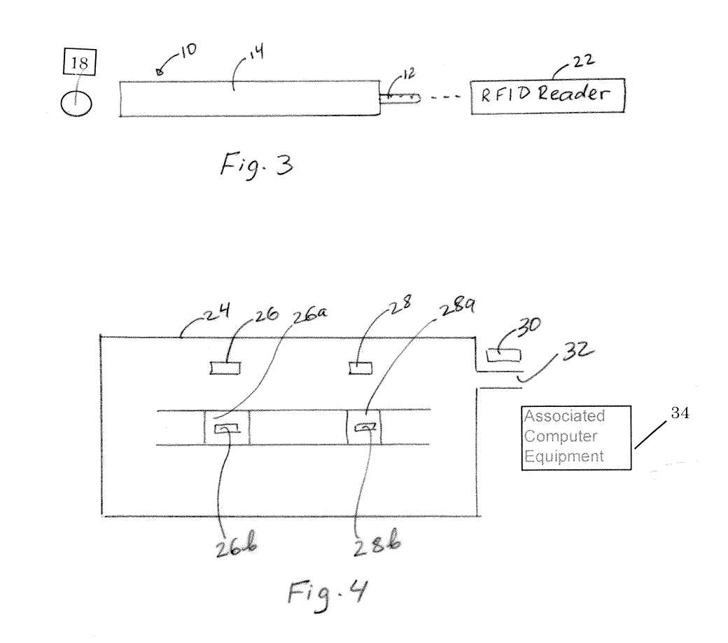

FIGS. 1 and 2 illustrates one example of a key with improved security. They are not views of an actual master key that is currently used by the TSA and other screening entities, and the bitting cuts are not the actually used cuts, so the figures would not assist in reproduction of the actual key from the drawing. The illustrated key 10 comprises a blade 12 and a bow or handle 14. Blade 12 has a bitting 16 with cuts therein and may have a profiled keyway (not illustrated). While the entire key 10 may be made of a single material or may have a differently shaped bow or handle, in the illustrated case metal key blade 12 is inserted into handle 14 made of another softer material; for example handle 14 is molded around a portion of blade 12 that is illustrated in broken lines. The security features of key 10 can include one or more of the following: one or more RFID tags 16, with or without associated integrated circuits (chips), that can be placed on blade 12 and/or handle 14, in a single orientation or in different orientations (e.g., a tag 16 on the front of key 10, as seen in FIG. 1 and another tag 16 on the side of key 10, as seen in FIG. 2); one or more RFID tags 16a, also with or without associated chips, placed inside handle 14 so that are protected from view and easy tampering, for example placed on the portion of blade 12 that extends into handle 14 or molded inside handle 14; and/or possible other places on or in key 10 and/or on or in attachments to key 10, such as tags 18 (see FIG. 3) that are separate from key 10 but are permanently or removably secured to the key. Alternatively or in addition, the security features can include one or more of: markings 20 on the visible portions of blade 12 and/or handle 14, on one or more of the sides of key 10; and markings 20a that are not visible but are on the portion of blade 12 that extends into handle 14 or are on an internal portion of handle 20. As stated above, the markings can be one or more of: the name or other designation of the airport facility to which it is assigned; the workstation to which the key is assigned; the name of other designation of the accountable property officer responsible for the key or keys assigned to the care of that officer; a serial number of the key; the name or other designation of the screening agent; and/or other markings. The markings can be engraved or molded or imprinted or in the form of stickers, or can be placed on or in the key in some other way. One reason for placing two or more RFID tags that are in non-parallel planes is to improve chances of good coupling with RFID readers.

Each respective RFID tag and marking can uniquely identify a specific key 10, or a specific set of keys 10, or a respective workstation or group of stations, or a screening facility or group of facilities, or some other grouping of keys. The RFID readers typically are associated with respective computer equipment that can drive a reader to repeatedly interrogate RFID tags and detect the presence of absence thereof, and can generate respective alarms and register the alarms.

FIG. 3 illustrates an example of a key 10 that can be the key of FIGS. 1 and 2, associated with RFID reader, and having an attachment 18 that can be a tag attached to key 10 with a chain or otherwise or affixed to key 10 with a fastener, adhesive or otherwise. Tag 18 can be provided with visible or hidden RFID tags and/or visible or hidden markings similar to those of key 10. RFID reader 22 can operate by detecting the presence of key 10 within its range, for example 5-30 feet, and/or by detecting the absence of key 10 from its range. In the latter case, reader 22 can be at or near an exit from a secure area, to thereby detect the removal of key 10 from the secure area and generating an alarm and/or registering the removal event. In the former case, reader 22 can be in the vicinity of a workstation at which an agent is screening luggage, in an environment in which key 10 is assigned to that workstation, and reader 22 repeatedly detects the presence of the key in its range and provides an alarm when it fails to detect the presence of the key, i.e., when the key has been removed from its assigned area.

FIG. 4 illustrates a simplified arrangement using both types of RFID readers to secure keys used in an area 24, which can be a room with workstations 26a and 26b, each designed for an agent to screen luggage with the use as needed of a respective key 10. Reader 26 queries key 10 that is at station 26a at selected times and, if it detects the absence of the key, issues an alarm and may register the event. Reader 28 similarly detects the absence of the respective key assigned to station 28a and issues an alarm if the key is no longer at that station. Alternatively or in addition, RFID reader 30 is at or near an exit 32 from secure area 24 to detect the presence of a key 10 within its range and issue an alarm when a key is being taken out through exit 32 and register the event.

In one example of use, screening agents in an airport or a similar facility are in a secure area through which checked luggage passes or through which checked luggage is delivered, and physically screen at least selected luggage by using key 10 to open dual function locks on the luggage that have indicia indicating that they can be opened with key 10. In one example, a key 10 with unique RFID and/or marking can be issued to a specific screening agent, possibly for a specific shift, or to a specific workstation such as station 26a. In that example, the agent stays at workstation 26a, opens the lock of a piece of luggage 26b, screens the contents, re-locks the piece of luggage, and repeats for other pieces of luggage while remaining at station 26a. If the agent forgets key 10 in a piece of luggage and the piece is moved such that it gets outside the range of reader 26, when the reader next queries the RFID tag of the key it detects the absence of a response from the tag, and the associated computer equipment 34 generates an alarm and if desired registers the event. Similarly, an alarm and possible a registration of the event would be generated if key 10 is supposed to remain at station 26 and the screening agent walks off with it outside the range of reader 26. Similar operations take place at workstation 28a with respect to a piece of luggage 28b, where the respective key 10 is monitored with reader 28. In another example of use, reader 30 is configured to detect the presence of any key 10 at or near exit 32 from the secure facility, and generates an alarm and possibly a registration of the event if a key is being taken out of secure area 24. If key 10 is photographed, the photograph is likely to include a visible marking 20 (which as illustrated in broken lines in FIG. 1 can extend to the bitting cuts), to facilitate tracing the photographing event to a particular key, a person or group entrusted with the key, or a facility to which the key belongs. A bogus key is unlikely to have the RFID tags and/or markings of an authorized key.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered as illustrative and not restrictive, and the body of work described herein is not to be limited to the details given herein, which may be modified within the scope of equivalents.

What is claimed is:

1. A master key for use by security operations inspecting travelers' luggage, comprising:
a handle adapted to be grasped by a user's hand and an operating portion configured to be coupled with a dual-function lock that has a traveler-operated locking mechanism and a locking mechanism operated by the master key, each locking mechanism configured to open the lock while the other lacking mechanism is in a locked position; and
an electrical circuit built-in or secured to the master key and configured to respond wirelessly with an electronic facility that responds to changes in location of the master key relative to a physical area or volume associated with a luggage screening operation.

2. The master key of claim 1, in which the electrical circuit is an active electronic circuit.

3. The master key of claim 2, in which the active electronic circuit comprises a wireless emitter as well a wireless transmitter, tuned for communication with said electronic facility.

4. The master key of claim 1, in which the electrical circuit comprises a passive circuit tuned to one or more frequencies of wireless signals emitted by said electronic facility.

5. The master key of claim 1, in which the electrical circuit is embedded in the key and is not visible from outside the key.

6. The master key of claim 5, in which the electrical circuit is protected from ohmic electrical communication by a portion of the key that is electrically insulating.
